(19) United States
(12) Patent Application Publication
(10) Pub. No.: US 2020/0372431 A1
(43) Pub. Date: Nov. 26, 2020

(54) MODEL GENERATING DEVICE, DEMAND FORECASTING DEVICE, DEMAND FORECASTING METHOD, AND PROGRAM

(71) Applicant: Panasonic Intellectual Property Management Co., Ltd., Osaka (JP)

(72) Inventors: Yoshiyuki OKIMOTO, Nara (JP); Hidehiko SHIN, Osaka (JP); Tomoaki ITOH, Tokyo (JP); Atsushi MIYATA, Osaka (JP)

(21) Appl. No.: 16/989,133

(22) Filed: Aug. 10, 2020

Related U.S. Application Data
(63) Continuation of application No. PCT/JP2019/004164, filed on Feb. 6, 2019.

(30) Foreign Application Priority Data
Feb. 15, 2018 (JP) 2018-025340

(51) Int. Cl. G06Q 10/06; G06N 5/04; G06N 5/02; G06Q 10/04; G06Q 30/02; G06Q 10/08; G06Q 50/12

(52) U.S. Cl. CPC G06Q 10/06315; G06N 5/04; G06N 5/02; G06Q 50/12; G06Q 10/067; G06Q 30/0202; G06Q 10/087; G06Q 10/04

(57) ABSTRACT

A model generating device according to the present disclosure includes: an acquisition unit that acquires demand information indicative of the number of sales of a product in a shop for a past predetermined period and external information relevant to the number of sales of the product; and a controller that generates a forecasting model for calculating a forecast value of demand for the product based on the demand information and the external information, wherein the controller includes a simulator that simulates the number of displayed pieces of the product based on the demand information and the forecast value and a forecasting model generator that generates the forecasting model based on the external information and the number of displayed pieces of the product and calculates the forecast value by using the forecasting model.

### CROSS-REFERENCE TO RELATED APPLICATIONS

This is a continuation application of International Application No. PCT/JP2019/004164, with an international filing dare of Feb. 6, 2019, which claims priority of Japanese Patent Application No.: 2018-025340 filed on Feb. 15, 2018, the content of which is incorporated in herein by reference.

### BACKGROUND OF THE INVENTION

### Technical Field

The present disclosure relates to a model generating device that generates a forecasting model, a demand forecasting device, a demand forecasting method, and a program that forecasts demand by using the forecasting model.

### Description of the Related Art

Japanese Unexamined Patent Application Publication No. 10-228463 discloses a demand forecasting model evaluation method suitable for evaluating the usefulness of a constructed demand forecasting model in actual work. In this demand forecasting model evaluation method, a calculator receives a demand actual value and a demand forecast value during an evaluation period and calculates a deviation value between the demand actual value and the demand forecast value in each cycle of product supply to the market that is input from an input device. The computer calculates an excess supply cost and an insufficient supply cost based on the deviation value and supplies the excess supply cost and the insufficient supply cost to an output device. This speeds up and facilitates evaluation work that verifies usefulness in actual work by applying a demand forecasting model and suppresses unnecessary reconstruction of a demand forecasting model for achieving accuracy higher than that required by a business system.

### SUMMARY

The present disclosure provides a model generating device that generates a forecasting model that reduces opportunity loss, a demand forecasting device that forecasts demand by using the forecasting model, a demand forecasting method, and a program.

A model generating device according to the present disclosure includes an acquisition unit that acquires demand information indicative of the number of sales of a product in a shop for a past predetermined period and external information relevant to the number of sales of the product and a controller that generates a forecasting model for calculating a forecast value of demand for the product based on the demand information and the external information, wherein the controller includes a simulator that simulates the number of displayed pieces of the product based on the demand information and the forecast value and a forecasting model generator that generates the forecasting model based on the external information and the number of displayed pieces of the product and calculates the forecast value by using the forecasting model.

A demand forecasting device according to the present disclosure is a demand forecasting device for forecasting demand by using a forecasting model generated by the model generating device and includes an acquisition unit that acquires display information indicative of the number of displayed pieces of the product at a present time in a shop and external information relevant to the number of sales of the product at the present time and a second controller that updates the forecasting model based on the display information and the external information and calculate a forecast value of demand for the product by using the updated forecast model.

These general and specific aspects may be realized by a system, a method, a computer program, or any combination thereof.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

According to the model generating device, the demand forecasting device, the demand forecasting method, and the program according to the present disclosure, a forecasting model is generated and updated based on the number of displayed pieces of a product, and it is therefore possible to reduce an opportunity loss resulting from lack of stock.

### BRIEF DESCRIPTION OF THE DRAWINGS

FIG. 1 is a block diagram illustrating configurations of a model generating device and a demand forecasting device according to a first embodiment and a second embodiment;

FIG. 2 is a diagram illustrating an example of simulation according to the first embodiment and the second embodiment;

FIG. 3 is a diagram for explaining operation of the model generating device according to the first embodiment;

FIG. 4 is a diagram illustrating an example of an explanatory variable according to the first embodiment;

FIG. 5 is a flowchart illustrating a forecasting model generation process according to the first embodiment;

FIG. 6 is a diagram for explaining operation of the demand forecasting device according to the first embodiment;

FIG. 7 is a flowchart illustrating a demand forecasting process according to the first embodiment;

FIG. 8 is a diagram for explaining operation of the model generating device according to the second embodiment;

FIG. 9 is a flowchart illustrating a forecasting model generation process according to the second embodiment;

FIG. 10 is a diagram for explaining operation of the demand forecasting device according to the second embodiment; and

FIG. 11 is a flowchart illustrating a demand forecasting process according to the second embodiment.

### DETAILED DESCRIPTION

(Knowledge Underlying Present Disclosure)

In a store that provides fast food (for example, hamburger), a customer waits in the store during cooking of fast food until the fast food is completed. However, in the case of counter fast food (for example, fried chicken) placed, for example, at a cashier counter of a convenience store, if there is no cooked stock, a customer will leave the convenience store without waiting for completion of cooking. Therefore, if cooked counter fast food becomes out of stock due to insufficient cooking, an opportunity loss occurs due to the customer giving up. However, the opportunity loss resulting from lack of stock cannot be calculated from the number of sales obtained from POS data. That is, it is not possible to know from the number of sales whether or not the customer had purchase intention. Therefore, in the demand forecasting using past POS data, an opportunity loss resulting from lack of stock cannot be taken into consideration.

The present disclosure provides a model generating device that generates a forecasting model that reduces an opportunity loss resulting from lack of stock and a demand forecasting device that forecasts demand by using the forecasting model. Specifically, the model generating device generates a forecasting model based on the number of displayed pieces of a product. By generating the forecasting model based on the number of displayed pieces of the product, it is possible to reduce an opportunity loss resulting from lack of stock in the demand forecasting using the forecasting model. Therefore, an increase in the number of sales can be expected.

### First Embodiment

A first embodiment will be described below with reference to the drawings. The present embodiment discusses, as an example, a case where a product that is a target of demand forecasting is a food product (e.g., a counter fast food product sold at a convenience store).

In the present embodiment, the forecasting model is generated based on not only the number of displayed pieces of the product but also the number of discarded pieces of the product. By generating the forecasting model based on the number of discarded pieces of the product, it is possible to reduce food product waste resulting from overproduction in the demand forecasting using this forecasting model. Therefore, the cost can be reduced.

In the present embodiment, both a reduction in opportunity loss and a reduction in discard cost are realized by generating a forecasting model based on the number of displayed pieces of the product and the number of discarded pieces of the product.

1.1 Configuration

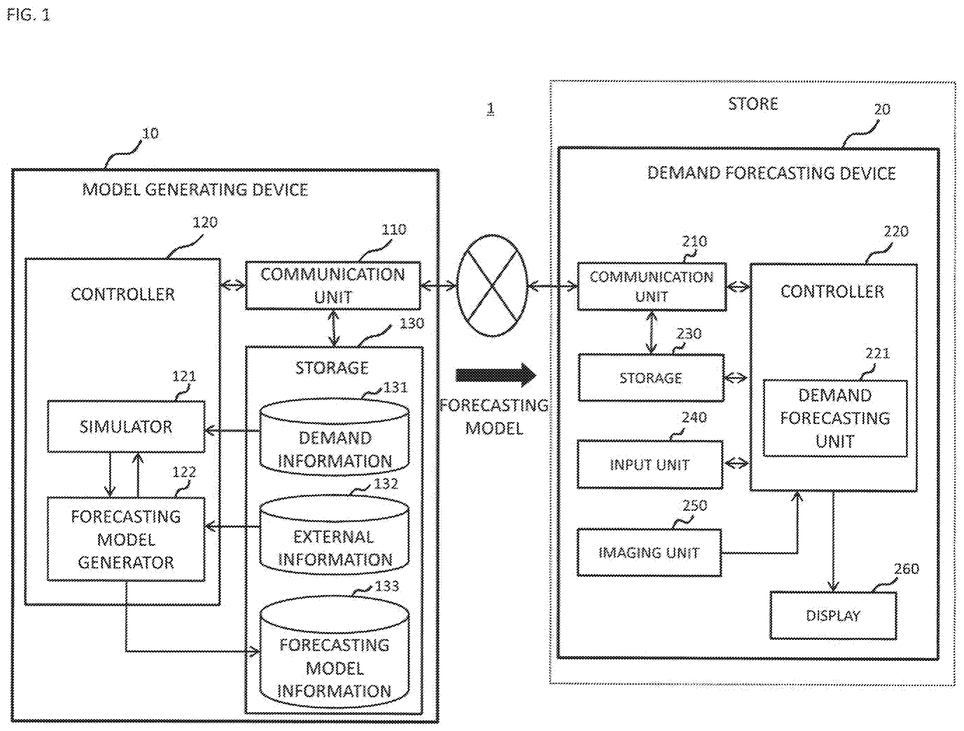

FIG. 1 illustrates configurations of a model generating device 10 and a demand forecasting device 20 according to the first embodiment. The model generating device 10 and the demand forecasting device 20 constitute a demand forecasting system 1. The demand forecasting system 1 generates a forecasting model for forecasting demand for a product by simulation and forecasts the demand for the product by using the generated forecasting model. The model generating device 10 is a server. The demand forecasting device 20 is any of various information processing devices such as a POS terminal device, a personal computer, a tablet terminal, and a smartphone. For example, the model generating device 10 is a cloud server, and the demand forecasting device 20 is installed at a store (for example, a convenience store). The model generating device 10 and the demand forecasting device 20 are connected over the Internet.

1.1.1 Configuration of Model Generating Device

The model generating device 10 includes a communication unit 110, a controller 120, and a storage 130.

The communication unit 110 includes a circuit that communicates with an external device according to a predetermined communication standard. Examples of the predetermined communication standard include LAN, Wi-Fi (registered trademark), Bluetooth (registered trademark), USB, and HDMI (registered trademark). The communication unit 110 acquires demand information 131 and external information 132 from the demand forecasting device 20, a POS terminal device, a personal computer, or the like installed at the store, for example, over the Internet. The demand information 131 and the external information 132 acquired by the communication unit 110 are stored in the storage 130. The demand information 131 is information indicative of the number of sales of a product in the store during a past predetermined period (for example, one year). For example, the demand information 131 is information indicative of the number of sales of a product per predetermined period. The external information 132 includes information relevant to the number of sales of the store during a past predetermined period (for example, one year). For example, the external information 132 includes information such as a time or a time zone, a day of the week or a holiday, temperature, weather, and the number of customers near a parking lot or an entrance of the store. The demand information 131 and the external information 132 are actual data in the past. The communication unit 110 is an example of an acquisition unit that acquires the demand information 131 and the external information 132.

The controller 120 can be, for example, a semiconductor element. For example, the controller 120 can be a microcomputer, a CPU, an MPU, a GPU, a DSP, an FPGA, or an ASIC. Functions of the controller 120 may be realized by hardware only or may be realized by hardware in combination with software. The controller 120 realizes predetermined functions by reading out data and programs stored in the storage 130 and performing various arithmetic processes.

In the present embodiment, the controller 120 includes, as functional elements, a simulator 121 and a forecasting model generator 122. The simulator 121 simulates the number of sales of the product, the number of discarded pieces of the product, and the number of displayed pieces of the product based on the demand information 131 and a forecast value (the number of products to be cooked in the present embodiment) calculated by the forecasting model generator 122. The forecasting model generator 122 generates a forecasting model based on the external information 132, and the number of sales of the product, the number of discarded pieces of the product, and the number of displayed pieces of the product simulated by the simulator 121. The forecasting model generator 122 calculates a forecast value by using the generated forecasting model. The forecasting model generator 122 causes forecasting model information 133 indicative of the generated forecasting model to be stored in the storage 130. The forecasting model is, for example, a function indicative of the number of demanded pieces of the product according to time. The controller 120 is an example of an acquisition unit that acquires the demand information 131 and the external information 132 from the storage 130.

The storage 130 is a storage medium in which programs and data that are needed to realize the functions of the model generating device 10 are stored. The storage 130 can be, for example, a hard disk (HDD), an SSD, a RAM, a DRAM, a ferroelectric memory, a flash memory, a magnetic disk, or a combination thereof.

1.1.2 Configuration of Demand Forecasting Device

The demand forecasting device 20 includes a communication unit 210, a controller 220, a storage 230, an input unit 240, an imaging unit 250, and a display 260.

The communication unit 210 includes a circuit that communicates with an external device according to a predetermined communication standard. Examples of the predetermined communication standard include LAN, Wi-Fi (registered trademark), Bluetooth (registered trademark), USB, and HDMI (registered trademark). External information concerning a date of selling or a current time is acquired via the communication unit 210. The communication unit 210 may be connected to, for example, a POS terminal device installed at a store and acquire demand information indicative the number of sales of the product at a present time. The communication unit 210 is an example of a second acquisition unit that acquires the forecasting model information 133 from the model generating device 10.

The controller 220 can be, for example, a semiconductor element. For example, the controller 220 can be a microcomputer, a CPU, an MPU, a GPU, a DSP, an FPGA, or an ASIC. Functions of the controller 220 may be realized by hardware only or may be realized by hardware in combination with software. The controller 220 realizes predetermined functions by reading out data and programs stored in the storage 230 and performing various arithmetic processes. The controller 220 includes, as a functional element, a demand forecasting unit 221 that forecasts demand for the product by using the acquired forecasting model information 133.

The storage 230 is a storage medium in which programs and data that are needed to realize the functions of the demand forecasting device 20 are stored. The storage 230 can be, for example, a hard disk (HDD), an SSD, a RAM, a DRAM, a ferroelectric memory, a flash memory, a magnetic disk, or a combination thereof. The forecasting model information 133 acquired from the model generating device 10 is stored in the storage 230.

The input unit 240 is a user interface for receiving user's various operations. The input unit 240 can be a touch panel, a keyboard, buttons, switches, or a combination thereof. For example, discard information indicative of the number of discarded pieces of the product at the present time is input by a user by using a keyboard. Alternatively, the number of discarded pieces of the product may be automatically counted and input by a sensor. For example, demand information indicative of the number of sales of the product at the present time is acquired by a touch operation made by a store clerk on a touch panel concerning a product purchased by a customer. Alternatively, the number of sales of the product may be automatically counted and input from a POS terminal. The input unit 240 may include a bar code reader, and the bar code reader may acquire information on the number of purchased pieces of the product.

The imaging unit 250 is a camera including an image sensor such as a CCD image sensor or a CMOS image sensor. The imaging unit 250 generates image data by photographing a product in a counter fast food showcase. For example, the controller 220 analyzes the image data, and thus display information indicative of the number of displayed pieces of the product is acquired. The camera may be externally attached to the demand forecasting device 20. The demand forecasting device 20 may acquire image data generated by another camera via the communication unit 210. The demand forecasting device 20 may count the number of displayed pies of the product (the number of remaining pieces of the product) based on output of a weight sensor attached to a display shelf. In this case, the demand forecasting device 20 need not include the imaging unit 250.

The communication unit 210, the controller 220, the input unit 240, and the imaging unit 250 are an example of a second acquisition unit that acquires the number of sales of the product, the number of displayed pieces of the product, and the number of discarded pieces of the product at the present time in the store.

The display 260 is, for example, a liquid crystal display or an organic EL display. The display 260 displays a result of demand forecasting of the product. For example, the display 260 displays, as a result of demand forecasting, the number of demanded pieces of the food product after a predetermined time (e.g., 10 minutes).

1.2 Operation of Model Generating Device (Generation of Forecasting Model)

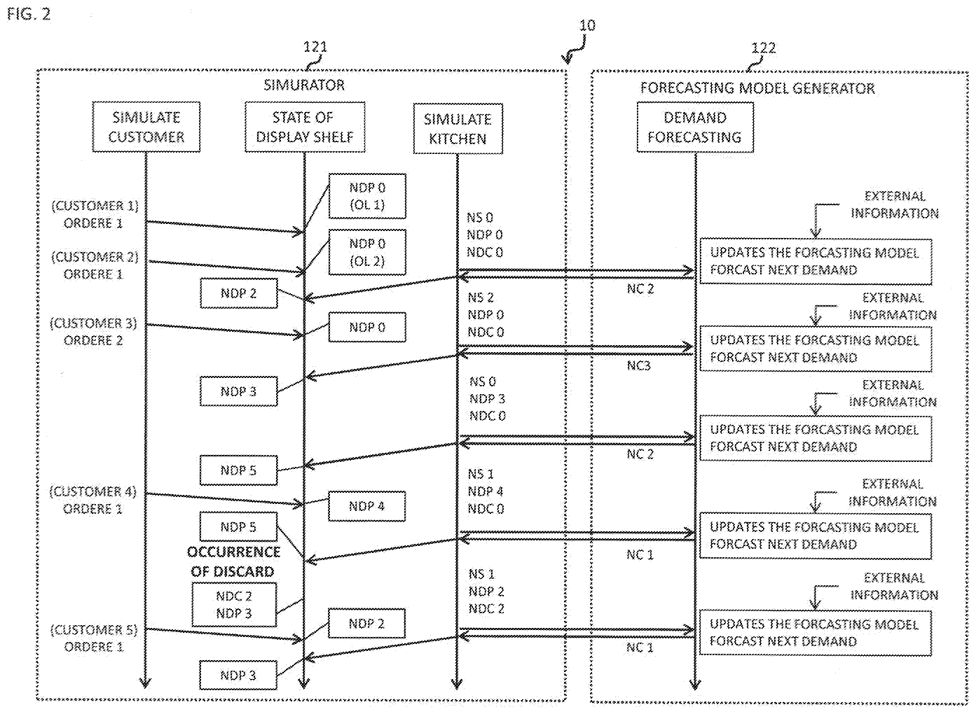

An outline of the simulation will be described with reference to FIG. 2. FIG. 2 illustrates a specific example of simulation of the number of sales of the product (NS), the number of displayed pieces of the product (NDP), and the number of discarded pieces of the product (NDC) by the simulator 121, and a forecast value (the number of pieces to be cooked (NC)) calculated by the forecasting model generator 122. The simulator 121 simulates, for example, the number of pieces of the product which prospective customers try to purchase (the number of pieces of the product ordered by of the customers illustrated in FIG. 2) based on the demand information 131. In the example of FIG. 2, the simulation starts from an initial state in which no product is displayed on a display shelf. When the first prospective customer tries to purchase one pieces of the product, the number of displayed pieces of the product is 0, and therefore no piece is purchased and the opportunity loss (OL) is 1. When the second prospective customer tries to purchase one piece of the product, the number of displayed pieces of the product is still 0, and therefore no piece is purchased and the opportunity loss is increased by 1 to 2.

The simulator 121 outputs the number of sales of the product, the number of displayed pieces of the product, and the number of discarded pieces of the product to the forecasting model generator 122 every predetermined time (e.g., 30 minutes). When the simulator 121 outputs the number of sales of the product “0”, the number of displayed pieces of the product “0”, and the number of discarded pieces of the product “0” to the forecasting model generator 122, 1.6 the forecasting model generator 122 updates the forecasting model based on the number of sales of the product “0”, the number of displayed pieces of the product “0”, and the number of discarded pieces of the product “0” and the external information 132 and forecasts next demand. In this example, the forecasting model generator 122 forecasts the number of pieces to be cooked “2” as the next demand and outputs the number of pieces to be cooked “2” to the simulator 121. The simulator 121 simulates that the number of displayed pieces of the product has become two based on the number of pieces to be cooked “2”. Note that the number of opportunity loss “2” is not output to the forecasting model generator 122 because the number of opportunity loss is a value that can be calculated by use of the simulator and is a number that cannot be known in actual operation. If a forecasting model is generated by using an unknown value, such a forecasting model will not be usable in actual operation. Therefore, in the present application, the number of displayed pieces of the product that can be known in actual operation is added as an input to the forecasting model. The forecasting model thus generated is therefore a model that can take the number of opportunity loss into consideration in the form of the number of displayed pieces of the product.

The simulator 121 simulates, based on the demand information 131, that the third prospective customer tries to purchase two pieces of the product. Since there are two pieces of the product on the display shelf, the two pieces of the product are purchased, and as a result the number of sales of the product becomes two, and the number of displayed pieces of the product becomes zero. When the simulator 121 outputs the number of sales of the product “2”, the number of displayed pieces of the product “0”, and the number of discarded pieces of the product “0” to the forecasting model generator 122, the forecasting model generator 122 updates the forecasting model based on the number of sales of the product “2”, the number of displayed pieces of the product “0”, and the number of discarded pieces of the product “0” and the external information 132 and forecasts next demand.

In this example, the forecasting model generator 122 forecasts the number of pieces to be cooked “3” as the next demand and outputs the number of pieces to be cooked “3” to the simulator 121. The simulator 121 simulates that the number of displayed pieces of the product has become three based on the number of pieces to be cooked “3”.

The simulator 121 calculates the number of discarded pieces of the product, for example, assuming that pieces of the product that have passed one hour after cooking are discarded. The time from cooking to discard is set depending on the kind of product. The simulator 121, when simulating occurrence of discard, subtracts the number of discarded pieces of the product from the number of displayed pieces of the product. In the example of FIG. 2, the number of displayed pieces of the product becomes three since five pieces of the product are displayed on the display shelf and two pieces of the product are discarded. In this case, the simulator 121 outputs the number of sales of the product “1”, the number of displayed pieces of the product “2”, and the number of discarded pieces of the product “2” in next output to the forecasting model generator 122. The forecasting model generator 122 updates the forecasting model based on the number of sales of the product “1”, the number of displayed pieces of the product “2”, the number of discarded pieces of the product “2”, and the external information 132, and forecasts next demand.

In this way, the forecast model is updated by repeating the simulation of the number of sales of the product, the number of displayed pieces of the product, and the number of discarded pieces of the product by the simulator 121, and update of the forecasting model and forecasting of next demand (calculation of forecast values) by the forecasting model generator 122.

The forecasting model is, for example, a function expressed by expression (1). In expression (1), t is a forecast target time, t−1 is a forecast execution time, i is a temporal difference between the forecast target time and a current or past time, w and v are weight coefficients, y is the number of demanded pieces of the product (=the number of sales of the product), u is an external variable such as a time zone, a day of the week, and weather, j is an ID for identifying the type of external variable such as a time zone, a day of the week, and weather, and σ is an error. The forecast execution time t−1 is a time at which forecasting operation based on expression (1) is executed and corresponds to the current time. In expression (1), the forecast target time t is a time one period ahead of the current time. According to expression (1), the number of demanded pieces of the product yₜ at the forecast target time t is forecast based on the current and past numbers of demanded pieces of the product yₜ₋ᵢ and the current external variable uₜ₋₁.

(Expression 1)

yₜ=Σᵢ₌₁ⁿwᵢyₜ₋ᵢ+Σⱼ₌₁^{m}vⱼuₜ₊₁^{j}+σ (1)

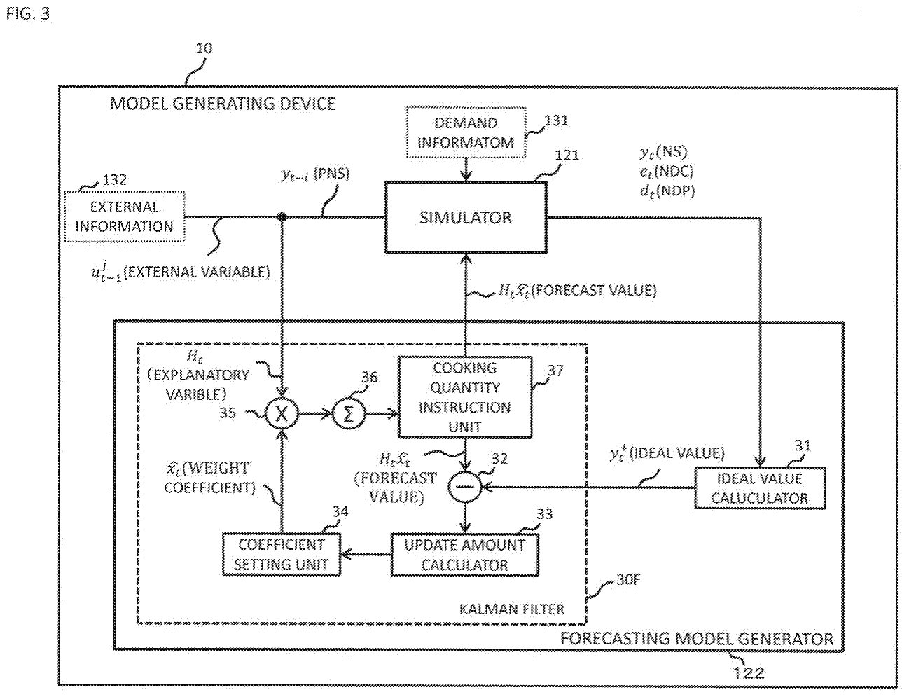

Generation and update of the forecasting model in the present embodiment will be described with reference to FIGS. 3 to 5.

FIG. 3 illustrates a functional configuration inside the forecasting model generator 122 of the model generating device 10 according to the first embodiment together with the simulator 121. The simulator 121 outputs the number of sales of the product (NS) yₜ, the number of discarded pieces of the product (NDC) eₜ, and the number of displayed pieces of the product (NDP) dₜ based on the demand information 131 and a forecast value.

The forecasting model generator 122 includes an ideal value calculator 31 and a Kalman filter 30F. In the present embodiment, the forecasting model expressed by expression (1) is generated as expression (2) by the Kalman filter 30F.

[Expression 2]

[symbol]

=Hₜ· [symbol] (2)

In expression (2),

[symbol]

,

[symbol]

indicate forecast values.

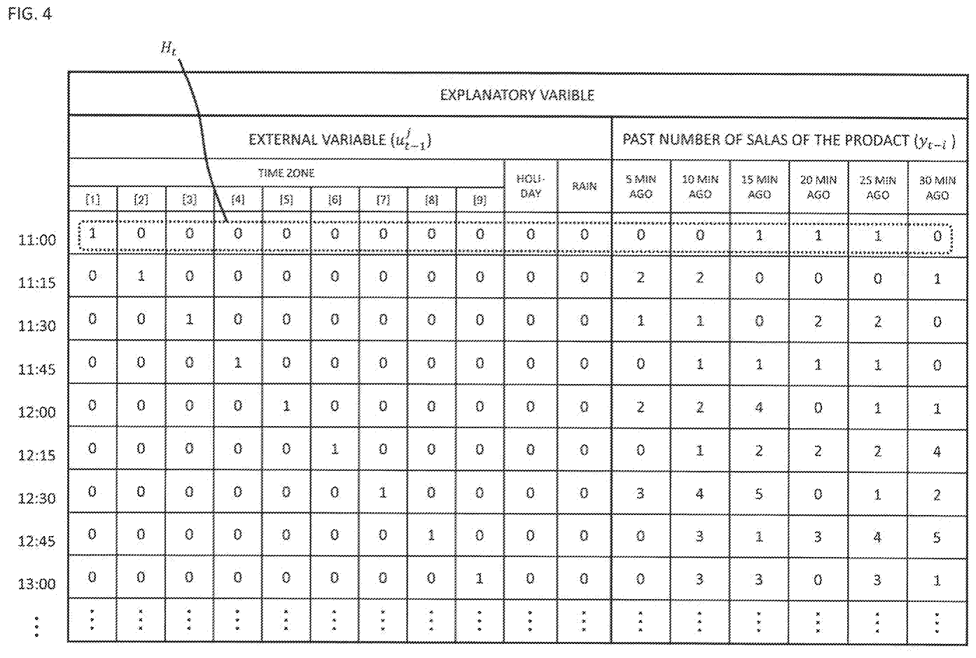

Expression (2) corresponds to the forecasting model of expression (1). Specifically, the explanatory variable Hₜ in expression (2) corresponds to a vector including the past number of sales of the product (PNS) yₜ₋ᵢ (i=1 to n) and the external variable u^{j} (j=1 to m) in expression (1) (see FIG. 4). The weight coefficient xₜ in expression (2) corresponds to a vector including the weight coefficients wᵢ and vⱼ (i=1 to n, j=1 to m) in expression (1).

The ideal value calculator 31 calculates an ideal value of the number of pieces to be cooked according to expression (3) based on the number of sales of the product yₜ, the number of discarded pieces of the product eₜ, and the number of displayed pieces of the product dₜ output from the simulator 121. In expression (3),

yₜ⁺

represents an ideal value.

$$\begin{matrix}[ Expression 3 ] & \\ {y}_{t}^{+} = \{ \begin{matrix}{y}_{t} + 1 ( {e}_{t} = 0 and {d}_{t} = 0 ) \\ {y}_{t} ( other cases )\end{matrix} & ( 3 )\end{matrix}$$

The Kalman filter 30F includes, as functional elements, a subtracting unit 32, an update amount calculator 33, a coefficient setting unit 34, a multiplying unit 35, a summing unit 36, and a cooking quantity instruction unit 37.

The subtracting unit 32, the update amount calculator 33, and the coefficient setting unit 34 set the weight coefficient xₜ according to expressions (4) and (5).

[Expression 4]

x̅ₜ= [symbol] +Kₜ(yₜ⁺−Hₜ\hat{x}ₜ) (4)

In expression (4), Kₜ represents Kalman gain.

\hat{x}ₜ

represents a weight coefficient before update.

x̅ₜ

represents a weight coefficient after update.

Kₜ(yₜ⁺−Hₜ\hat{x}ₜ)

represents an update amount.

[Expression 5]

\hat{x}ₜ=Fₜ·x̅ₜ̅₋̅₁̅ (5)

Specifically, the subtracting unit 32 calculates a difference between the ideal value and a previous forecast value. The update amount calculator 33 calculates the Kalman gain Kₜ, and calculates an update amount from the difference between the ideal value and the previous forecast value and the Kalman gain Kₜ. The Kalman gain Kr is calculated based on a forecast error variance Vₜ of the weight coefficient xₜ. The coefficient setting unit 34 updates a previous weight coefficient xₜ₋₁ based on the update amount and sets a new weight coefficient xₜ. In expression (5), Fₜ is 1 (unit matrix) in the present embodiment. That is, the coefficient setting unit 34 uses the updated weight coefficient obtained by expression (4) as a weight coefficient one period ahead.

The multiplying unit 35 and the summing unit 36 calculate a forecast value one period ahead according to expression (2) by using the weight coefficient one period ahead. “Hₜ·xᵥ” in expression (2) indicates that the summing unit 36 calculates a sum of multiplication results of “wᵢ·yₜ₋ᵢ” and “vⱼ·uⱼ” in expression (1) by the multiplying unit 35. The cooking quantity instruction unit 37 outputs the calculated forecast value to the simulator 121.

As described above, the Kalman filter 30F calculates a next forecast value yₜ (=Hₜ·xₜ) while updating the weight coefficient xₜ based on the difference between the forecast value and the ideal value.

FIG. 4 illustrates an example of the explanatory variable Hₜ used for generation of the forecasting model. The explanatory variable Hₜ includes the external variable u^{j} and the number of sales of the product in the past yₜ₋ᵢ. The external variable u^{j} is acquired or generated from the external information 132 and indicates a time zone, whether it is a holiday or not, and whether it is raining or not in the example of FIG. 4, The number of sales of the product in the past yₜ₋ᵢ is obtained from a result of simulation by the simulator 121. For example, the number of sales of the product in the past yₜ₋ᵢ at 11:00 includes the number of sales of the product during a period from 10:55 (5 minutes ago) to 11:00 (a present time), the number of sales of the product during a period from 10:50 (10 minutes ago) to 10:55 (5 minutes ago), the number of sales of the product during a period from 10:45 (15 minutes ago) to 10:50 (10 minutes ago), the number of sales of the product during a period from 10:40 (20 minutes ago) to 10:45 (15 minutes ago), the number of sales of the product during a period from 10:35 (25 minutes ago) to 10:40 (20 minutes ago), and the number of sales of the product during a period from 10:30 (30 minutes ago) to 10:35 (25 minutes ago).

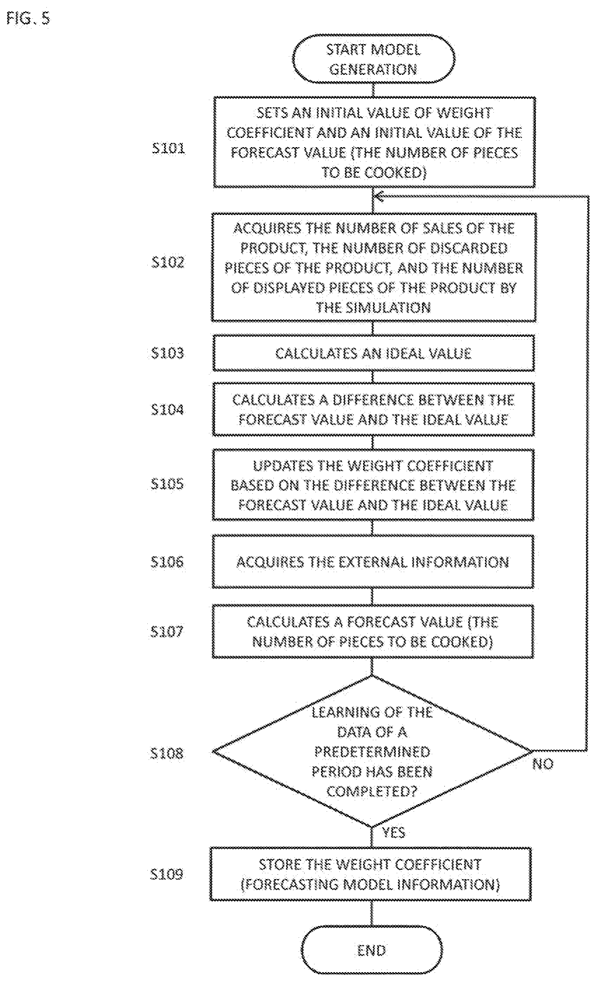

FIG. 5 is a flowchart illustrating operation of the forecasting model generator 122. The forecasting model generator 122 sets an initial value of the weight coefficient xₜ and an initial value of the forecast value yₜ (the number of pieces to be cooked) (S101). The forecasting model generator 122 acquires the number of sales of the product yₜ, the number of discarded pieces of the product eₜ, and the number of displayed pieces of the product dₜ from the simulator 121 (S102).

The ideal value calculator 31 of the forecasting model generator 122 calculates an ideal value of the number of pieces to be cooked based on the number of discarded pieces of the product eₜ and the number of displayed pieces of the product dₜ, as shown in expression (3) (S103). Specifically, the ideal value calculator 31 sets, as the ideal value, a value obtained by adding “1” to the number of sales of the product yₜ only when “the number of discarded pieces of the product eₜ=0 and the number of displayed pieces of the product dₜ=0”. As a result, in a case where no piece is discarded and the display shelf becomes empty within a predetermined time interval (e.g., 30 minutes) of a cooking instruction, the weight coefficient xₜ is modified to approach the value obtained by adding “1” to “the number of sales of the product” within the time interval in step S105, which will be described later. Meanwhile, the ideal value calculator 31 sets the number of sales of the product yₜ as the ideal value unless “the number of discarded pieces of the product eₜ=0 and the number of displayed pieces of the product dₜ=0”. As a result, in a case where a product is discarded or the display shelf does not become empty within the predetermined time interval, the weight coefficient xₜ is modified to approach “the number of sales of the product” within the time interval in step S105.

The forecasting model generator 122 calculates a difference between the forecast value (the number of pieces to be cooked) and the ideal value by the Kalman filter 30E′ (S104) and updates the weight coefficient xₜ based or the difference (S105), as shown in expressions (4) and (5).

The forecasting model generator 122 acquires the external information 132 from the storage 130 (S106) and calculates a next forecast value (the number of pieces to be cooked) according to expression (2) (S107). Specifically, the forecasting model generator 122 generates the explanatory variable Hₜ including the external variable u and the number of sales of the product in the past yₜ₋ᵢ based on the numbers of sales of the product acquired in step S102 in the past and at present and the external information 132 acquired in step S106. The multiplying unit 35 and the summing unit 36 calculate a next forecast value according to expression (2) based on the generated explanatory variable Hₜ and the weight coefficient xₜ updated in step S105.

Although calculation of the ideal value based on expression (3) has been described in the present embodiment, the calculation of the ideal value is not limited to this. A formula for calculating the ideal value may be changed depending on the number of displayed pieces of the product. For example, the formula may be “the number of sales of the product+1” if “the number of discarded pieces of the product eₜ=0 and the number of displayed pieces of the product dₜ=1”, whereas the formula may be “the number of sales of the product eₜ+2” if “the number of discarded pieces of the product eₜ=0 and the number of displayed pieces of the product dₜ=0”. This creates a state where a certain number of pieces of the product are always displayed in the display case. Such a display can achieve a purchase promoting effect.

The forecasting model generator 122 determines whether or not learning of the forecasting model using the data of the demand information 131 and the external information 132 for a predetermined period (for example, one year) has been completed (S108). If the learning for the predetermined period has not been completed, the process returns to step S102. When the learning for the predetermined period is completed, the forecasting model information 133 indicative of the generated forecasting model is stored in the storage 130 (S109). For example, the weight coefficient xₜ is stored as the forecasting model information 133.

1.3 Operation of Demand Forecasting Device (Demand Forecasting Using Forecasting Model)

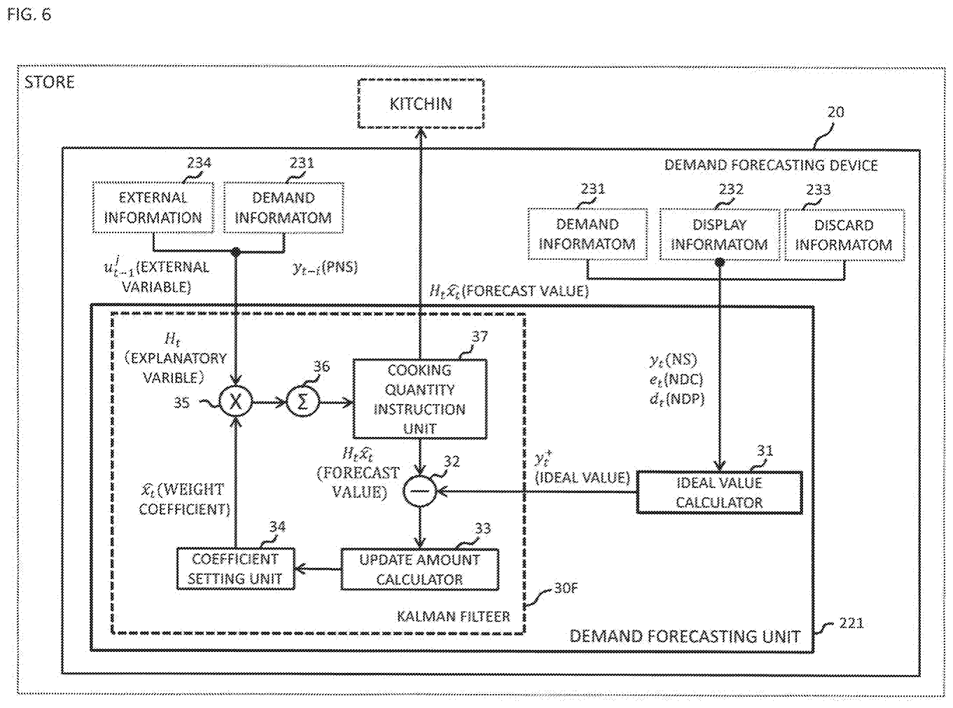

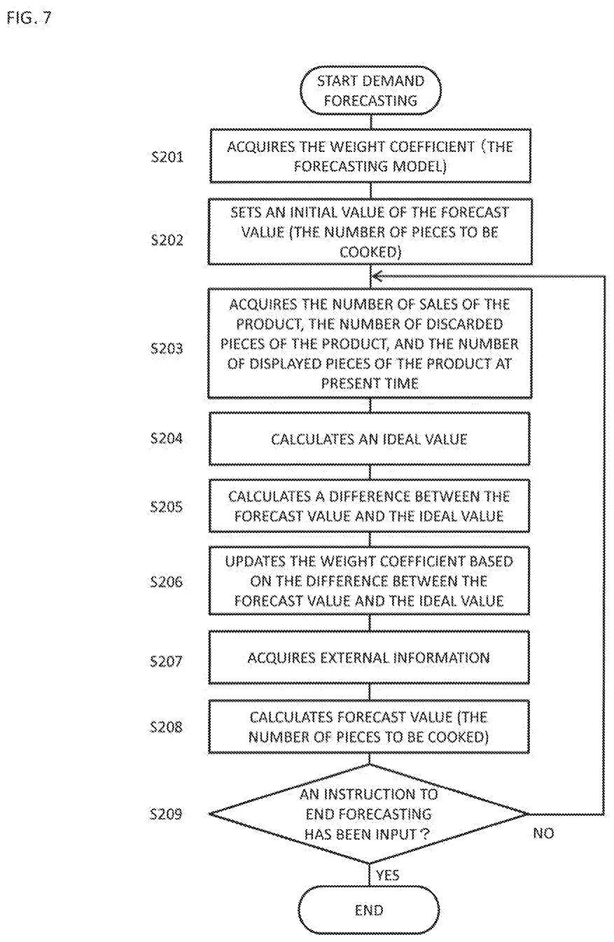

Demand forecasting using the forecasting model according to the present embodiment will be described with reference to FIGS. 6 and 7. FIG. 6 illustrates a functional configuration in the demand forecasting unit 221 of the demand forecasting device 20. The demand forecasting unit 221 includes an ideal value calculator 31 and a Kalman filter 30F, as in the model generating device 10. The demand forecasting device 20 calculates a forecast value yₜ (=Hₜ·xₜ) while updating the weight coefficient xₜ. Although the model generating device 10 calculates a forecast value by simulating the number of sales of the product (NS), the number of discarded pieces of the product (NDC), and the number of displayed pieces of the product (NDP), the demand forecasting device 20 calculates an actual forecast value by using the number of sales of the product yₜ, the number of discarded pieces of the product eₜ, and the number of displayed pieces of the product dₜ at a present time in the shop. FIG. 7 is a flowchart illustrating operation of the demand forecasting unit 221 of the demand forecasting device 20. A functional configuration of the demand forecasting unit 221 will be described below with reference to FIG. 7.

The demand forecasting unit 221 requests the model generating device 10 to transmit the forecasting model information 133 and thus acquires the forecasting model information 133 from the model generating device 10 (S201). For example, the demand forecasting unit 221 acquires the weight coefficient xₜ as the forecasting model information 133. The demand forecasting unit 221 sets an initial value of the forecast value (the number of pieces to be cooked) (S202). The demand forecasting unit 221 acquires demand information 231 indicative of the number of sales of the product yz, display information 232 indicative of the number of displayed pieces of the product dₜ, and discard information 233 indicative of the number of discarded pieces of the product eₜ (S203).

The ideal value calculator 31 of the demand forecasting unit 221 calculates an ideal value of the number of pieces to be cooked from the number of sales of the product yₜ, the number of discarded pieces of the product eₜ, and the number of displayed pieces of the product dr (S204). The demand forecasting unit 221 calculates a difference between the forecast value and the ideal value by the Kalman filter 30F (S205) and updates the weight coefficient xₜ based on the difference (S206).

The demand forecasting unit 221 acquires external information 234 at the present time, for example, via the communication unit 210 (S207). The external information 234 acquired by the demand forecasting unit 221 includes the same kind of information as the external information 132 acquired by the forecasting model generator 122. That is, the external information 234 includes a time zone, a day of the week (whether it is a holiday or not), and weather (whether it is raining or not). The demand forecasting unit 221 generates an explanatory variable Hₜ based on the number of sales of the product yₜ acquired in step S203 and the external information 234 acquired in step S207.

The demand forecasting unit 221 calculates a next forecast value (the number of pieces to be cooked) according to expression (2) based on the weight coefficient xₜ updated in step S206 and the explanatory variable Hₜ generated in step S207 (S208). The cooking quantity instruction unit 37 of the demand forecasting unit 221 gives an instruction about a cooking quantity to a cook in the kitchen, for example, by displaying the forecast value on the display 260.

The demand forecasting unit 221 determines whether or not an instruction to end forecasting has been input to the input unit 240 (S209. In a case where the instruction to end forecasting has not been input, the process returns to step S203, and the update of the weight coefficient and the calculation of the forecast value in steps S203 to S208 are repeated. In a case where the instruction to end forecasting has been input, the demand forecasting process ends.

The demand forecasting device 20 performs the calculation of the ideal value (S204), the calculation of the difference between the forecast value and the ideal value (S205), the update of the weight coefficient (S206), and the calculation of the forecast value (S208) in the same manners as the calculation of the ideal value (S103), the calculation of the difference between the forecast value and the ideal value (S104), the update of the weight coefficient (S105), and the calculation of the forecast value (S107) performed by the model generating device 10, respectively.

1.4 Effects and Supplements

The model generating device 10 according to the present embodiment has an acquisition unit (the communication unit 10 or the controller 120) that acquires demand information 131 indicative of the number of sales of a product in a store for a past predetermined period and external information 132 relevant to the number of sales and the controller 120 that generates a forecasting model for calculating a forecast value of demand for the product based on the demand information 131 and the external information 132. The controller 120 includes the simulator 121 that simulates the number of sales of the product, the number of displayed pieces of the product, and the number of discarded pieces of the product based on the demand information 131 and the forecast value and the forecasting model generator 122 that generates a forecasting model based on the external information 132, the number of sales of the product, the number of displayed pieces of the product, and the number of discarded pieces of the product and calculates a forecast value by using the forecasting model.

Specifically, the forecasting model generator 122 calculates an ideal value, which is the desired number of sales of the product, based on the number of sales of the product, the number of displayed pieces of the product, and the number of discarded pieces of the product. The ideal value is a modified forecast value based on estimation, from the number of displayed pieces of the product and the number of discarded pieces of the product, of an opportunity loss resulting from lack of stock, which is unable to be grasped as a numerical value and is not taken into consideration conventionally. The forecasting model is updated based on a difference between the previous forecast value and the ideal value by the Kalman filter 30F, and a next forecast value is calculated by using the updated forecasting model. Accordingly, the forecast value is always calculated so as to approach the ideal value.

More specifically, the forecasting model is a function for calculating a forecast value by multiplying a weight coefficient and an explanatory variable, and the forecasting model generator 122 generates an explanatory variable based on the number of sales of the product and external information, calculates an ideal value by changing the number of sales of the product based on the number of displayed pieces of the product and the number of discarded pieces of the product, and updates the weight coefficient based on a difference between the previous forecast value and the ideal value.

Since the number of displayed pieces of the product is used for generation of the forecasting model, it is possible to reduce the opportunity loss resulting from lack of stock by forecasting demand by using this forecasting model. Furthermore, since the number of discarded pieces of the product is used for generation of the forecasting model, it is possible to reduce the number of pieces discarded due to overproduction by forecasting demand by using this forecasting model. According to the model generating device according to the present disclosure, a reduction in cost and an increase in the number of sales can be expected.

The forecasting model generator 122 increases the ideal value in a case where the number of displayed pieces of the product and the number of discarded pieces of the product are zero. Thereby, a forecast value that can reduce the opportunity loss is calculated.

The demand forecasting device 20 according to the present embodiment forecasts demand by using the forecasting model generated by the model generating device 10. The demand forecasting device 20 has a second acquisition unit (the communication unit 210, the controller 220, the input unit 240, the imaging unit 250) that acquires the demand information 231 indicative of the number of sales of a product at a present time in a store, the display information 232 indicative of the number of displayed pieces of the product at the present time in the store, the discard information 233 indicative of the number of discarded pieces of the product at the present time in the store, and the external information 234 relevant to the number of sales of the product at the present time and a controller 220 that updates the forecasting model based on the demand information 231, the display information 232, the discard information 233, and the external information 234 and calculates a forecast value of demand for the product by using the updated forecasting model.

Since the demand is forecast by using the forecasting model generated based on the number of displayed pieces of the product, it is possible to reduce the opportunity loss resulting from lack of stock. By giving a cooking instruction while reducing the opportunity loss, an increase in the number of sales can be expected. Furthermore, it is possible to reduce the number of discarded pieces of the product resulting from overproduction by forecasting the demand by using the forecasting model generated based on the number of discarded pieces of the product. Cost can be reduced by reducing the number of discarded pieces of the product. It is therefore possible to notify a store operator of the optimum number of pieces to be cooked by using the demand forecasting device 20 according to the present embodiment.

### Second Embodiment

The present embodiment is different from the first embodiment in terms of how a forecast value is calculated by a forecasting model generator 122. In the first embodiment, the forecast value is calculated by using the Kalman filter 30F. In the second embodiment, a forecasting model is learned by reinforcement learning, and a forecast value is calculated by using the forecasting model. Specifically, in the present embodiment, Q learning is used as an example of the reinforcement learning. The forecasting model according to the present embodiment is an action value function Q (sₜ, aₜ). The action value function Q (sₜ, aₜ) indicates an expected value of a total sum of rewards obtained after taking an action aₜ in a state sₜ according to a strategy (policy) n. In the reinforcement learning according to the present embodiment, an environment corresponds to a simulator 121 or a kitchen, a state s of the environment corresponds to the number of sales of a product, the number of displayed pieces of the product, the number of discarded pieces of the product, weather, temperature, a day of the week, or the like, and an action a corresponds to the number of cooked pieces of the product (a forecast value). The second embodiment will be described below with reference to the drawings.

2.1 Operation of Model Generating Device (Generation of Forecasting Model)

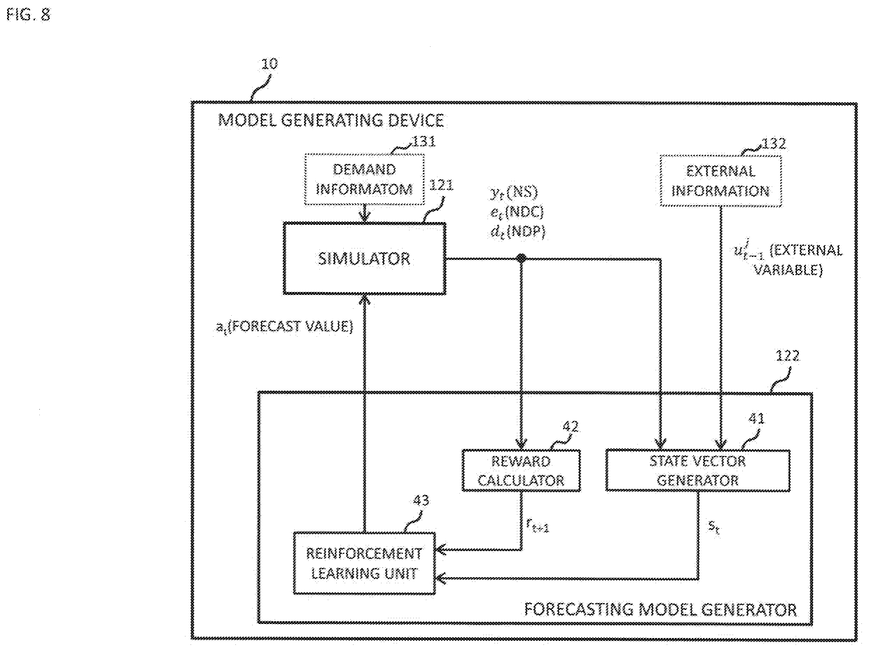

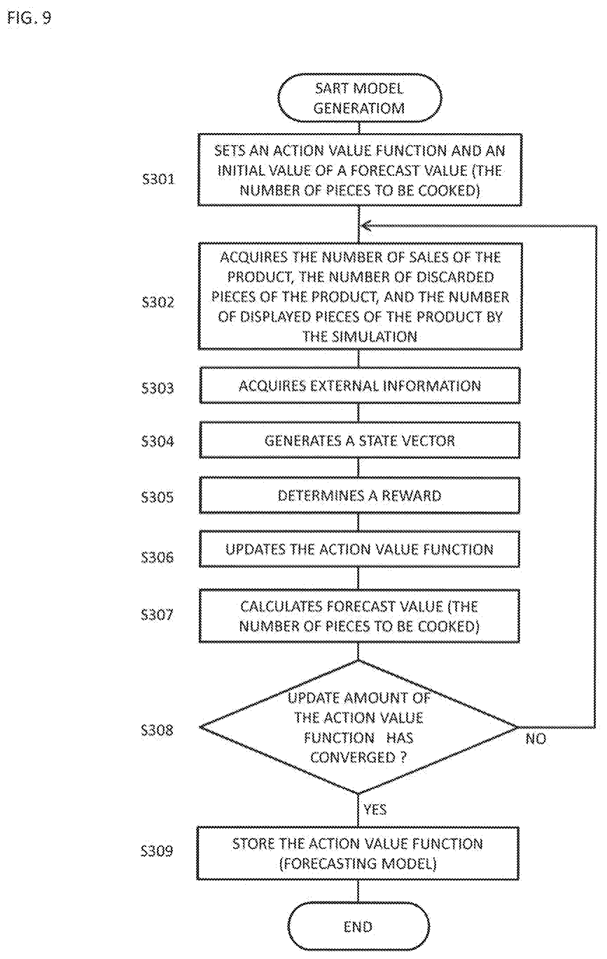

Generation and update of a forecasting model according to the present embodiment will be described with reference to FIGS. 8 and 9. FIG. 8 illustrates a functional configuration in a forecasting model generator 122 of a model generating device 10 according to the second embodiment. The forecasting model generator 122 according to the present embodiment includes a state vector generation unit 41, a reward calculator 42, and a reinforcement learning unit 43. FIG. 9 is a flowchart showing operation of the forecasting model generator 122. A functional configuration of the forecasting model generator 122 will be described with reference to FIG. 9.

The forecasting model generator 122 of the model generating device 10 sets an action value function Q (sₜ, aₜ) and an initial value of a forecast value (the number of pieces to be cooked) aₜ (S301).

As in the first embodiment, the simulator 121 simulates the number of sales yₜ of a product, the number of discarded pieces eₜ of the product, and the number of displayed pieces dₜ of the product based on demand information 131 and the forecast value. The forecasting model generator 122 acquires the number of sales yₜ of the product (NS), the number of discarded pieces eₜ of the product (NDC), and the number of displayed pieces dₜ of the product (NDP) from the simulator 121 (S302).

The forecasting model generator 122 acquires external information 132 from a storage 130 (S303). The state vector generation unit 41 of the forecasting model generator 122 generates a state vector sₜ based on the acquired number of sales yₜ of the product, the number of discarded pieces eₜ of the product, the number of displayed pieces dₜ of the product, and the external information 132 (S304). The state vector sₜ is, fox example, a vector based on an explanatory variable Hₜ illustrated in FIG. 4. The state vector sₜ may be a vector obtained by adding the number of discarded pieces eₜ and the number of displayed pieces dₜ to the explanatory variable Hₜ.

The reward calculator 42 of the forecasting model generator 122 determines a reward rₜ₊₁ based on the number of discarded pieces eₜ and the number of displayed pieces dₜ (S305). For example, the reward calculator 42 determines the reward rₜ₊₁ such that the reward increases as the number of discarded pieces eₜ decreases and the number of displayed pieces dₜ approaches a predetermined number. The predetermined number is appropriately determined, for example, depending on the kind of product. In the present embodiment, the reward r+i=1 when the number of discarded pieces eₜ=0 and the number of displayed pieces dₜ>0, the reward rₜ₊₁=0 when the number of discarded pieces eₜ=0 and the number of displayed pieces dₜ=0, and the reward rₜ₊₁=−1 when the number of discarded pieces eₜ>0. The reward rₜ₊₁ may be determined based on the number of sales yₜ in addition to the number of discarded pieces eₜ and the number of displayed pieces dr. Alternatively, the reward rₜ₊₁ may be a successively-changing reward. For example, the reward rₜ₊₁ may increase until the number of displayed pieces dₜ reaches a predetermined value and may be constant when the number of displayed pieces dₜ is the predetermined value or more.

The reinforcement learning unit 43 of the forecasting model generator 122 updates the action value function Q (sₜ, aₜ) in a case where the reward rₜ₊₁ is obtained in a next state sₜ₊₁ as a result of outputting aₜ as a forecast value in the state vector sₜ (S306). Specifically, the reinforcement learning unit 43 updates the action value function Q (sₜ, aₜ) based on expression (6). In expression (6), α represents a learning rate (0<α≤1), and γ represents a discount rate (0<γ≤1).

$$\begin{matrix}[ Expression 6 ] & \\ Q ( {s}_{t} , {a}_{t} ) ← Q ( {s}_{t} , {a}_{t} ) + α [ {r}_{t + 1} + γ {max}_{a} Q ( {s}_{t + 1} , a ) - Q ( {s}_{t} , {a}_{t} ) ] & ( 6 )\end{matrix}$$

The reinforcement learning unit 43 calculates the forecast value (the number of pieces to be cooked) aₜ using the updated action value function Q (sₜ, aₜ) (S307). The forecast value aₜ is calculated according to expression (7). As a result, a forecast value (the number of pieces to be cooked) aₜ which maximizes Q (sₜ, aₜ) in the state sₜ is calculated.

$$\begin{matrix}[ Expression 7 ] & \\ π ( s ) = {arg max}_{α} Q ( s , a ) & ( 7 )\end{matrix}$$

The forecasting model generator 122 determines whether or not learning of the forecasting model repeatedly using the data of the demand information 131 and the external information 132 for a predetermined period (for example, one year) has been completed. Specifically, the forecasting model generator 122 determines whether or not an update amount of the action value function Q (sₜ, aₜ) has converged (S308). If the update amount of the action value function Q (sₜ, aₜ) is large and the learning has not been completed, the process returns to step S302, and the update of the action value function by simulation and the calculation of the forecast value are continued. When the update amount of the action value function Q (sₜ, aₜ) becomes sufficiently small and the learning has been completed, forecasting model information 133 indicative of the generated forecasting model is stored in the storage 130 (S309). For example, the action value function Q is stored as the forecasting model information 133.

2.2 Operation of Demand Forecasting Device (Demand Forecasting Using Forecasting Model)

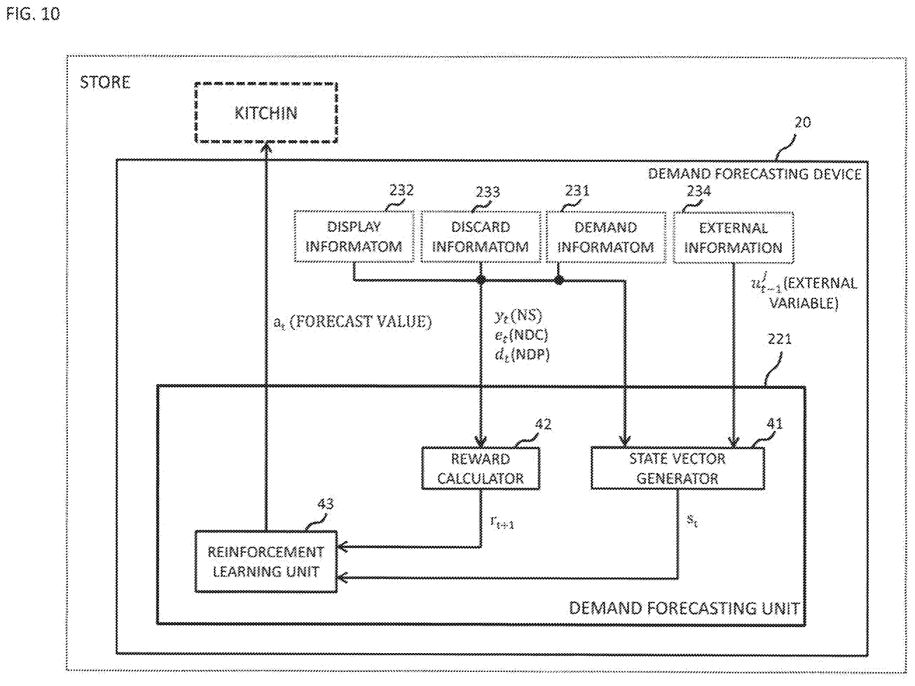

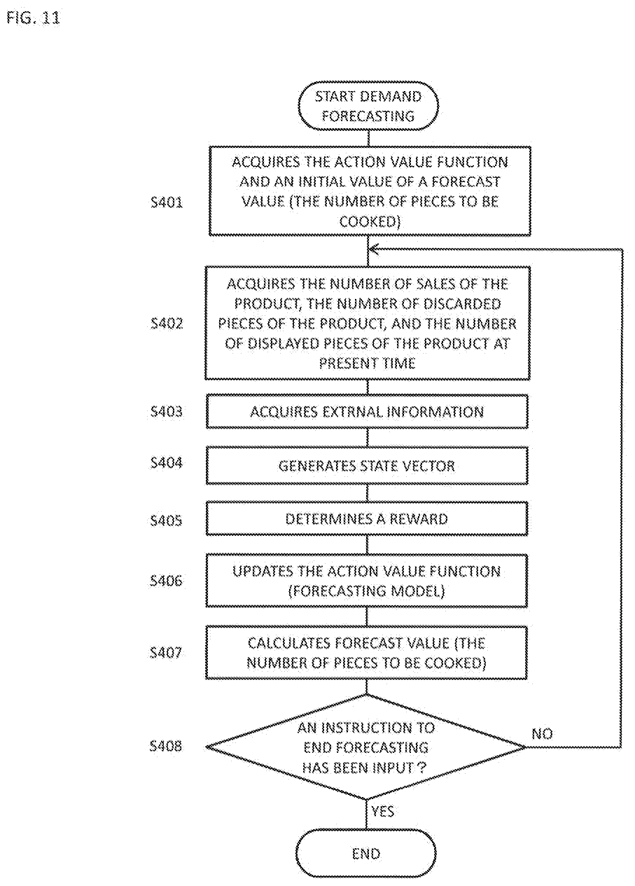

Demand forecasting using the forecasting model according to the present embodiment will be described with reference to FIGS. 10 and 11. FIG. 10 illustrates a functional configuration in the demand forecasting unit 221 of the demand forecasting device 20 according to the second embodiment. The demand forecasting unit 221 includes a state vector generation unit 41, a reward calculator 42, and a reinforcement learning unit 43, as with the model generating device 10. The demand forecasting device 20 calculates an actual forecast value while updating an action value function (a forecasting model) by reinforcement learning. The model generating device 10 calculates a forecast value by simulating the number of sales of a product, the number of discarded pieces of the product, and the number of displayed pieces of the product, but the demand forecasting device 20 calculates a forecast value by using the number of sales of the product, the number of discarded pieces of the product, and the number of displayed pieces of the product at a present time in a shop. FIG. 11 is a flowchart showing operation of the demand forecasting unit 221 of the demand forecasting device 20. A functional configuration of the demand forecasting unit 221 will be described with reference to FIG. 11.

The demand forecasting unit 221 of the demand forecasting device 20 requests the model generating device 10 to transmit the forecasting model information 133 and thus acquires the forecasting model information 133 from the model generating device 10 (2401). Specifically, the demand forecasting unit 221 acquires the action value function Q as the forecasting model information 133.

The demand forecasting unit 221 acquires demand information 231 indicative of the number of sales (NS) yₜ of the product at the present time, discard information 233 indicative of the number of discarded pieces (NDC) eₜ of the product at the present time, and display information 232 indicative of the number of displayed pieces (NDP) dₜ of the product at the present time (S402). The demand forecasting unit 221 acquires external information 234 on a date of selling or at the present time (S403). The external information 234 acquired by the demand forecasting unit 221 includes the same kind of information as the external information 132 acquired by the forecasting model generator 122.

The state vector generation unit 41 of the demand forecasting unit 221 generates a state vector sₜ based on the acquired number of sales yₜ, the number of discarded pieces er, the number of displayed pieces dₜ, and the external information 234 (S404). The reward calculator 42 of the demand forecasting unit 221 determines a reward rₜ₊₁ based on the number of discarded pieces eₜ and the number of displayed pieces dr (S405). The reinforcement learning unit 43 of the demand forecasting unit 221 updates the action value function Q (sₜ, aₜ), which is a forecasting model, based on the state vector sₜ and the reward rₜ₊₁ (S406). The reinforcement learning unit 43 calculates a forecast value (the number of pieces to be cooked) aₜ by using the updated action value function Q (sₜ, aₜ) (S407). The demand forecasting unit 221 gives an instruction about the number of pieces to be cooked to a cook in a kitchen, for example, by displaying the calculated forecast value on a display 260.

The demand forecasting unit 221 determines whether or not an instruction to end forecasting has been input to an input unit 240 (S408). In a case where the instruction to end forecasting has not been input, the process returns to step S402, and the update of the action value function and the calculation of the forecast value in steps S402 to S407 are repeated. In a case where the instruction to end forecasting has been input, the demand forecasting process ends.

The demand forecasting device 20 performs the generation of the state vector sₜ (S404), the determination of the reward rₜ₊₁ (S405), the update of the action value function Q (sₜ, aₜ) (S406), and the calculation of the forecast value aₜ (S407) in the same manners as the generation of the state vector sₜ (S304), the determination of the reward rₜ₊₁ (S305), the update of the action value function Q (sₜ, aₜ) (S306), and the calculation of the forecast value aₜ (S307) performed by the model generating device 10, respectively.

2.3 Effects and Supplements

The forecasting model generator 122 of the model generating device 10 according to the present embodiment updates a forecasting model by reinforcement learning and calculates a forecast value by using the forecasting model.

Specifically, the forecasting model is a function for calculating a forecast value based on a state vector and a reward, and the forecasting model generator 122 sets a state vector sₜ based on the external information 132, the number of sales of a product, the number of displayed pieces of the product, and the number of discarded pieces of the product and determines a reward rₜ₊₁ based on the number of displayed pieces of the product and the number of discarded pieces of the product.

The forecasting model generator 122 determines the reward rₜ₊₁ such that the reward increases as the number of discarded pieces of the product decreases and the number of displayed pieces of the product approaches a predetermined number. A larger number of displayed pieces can reduce the opportunity loss more, but too many displayed pieces may sometimes reduce eagerness to buy. In view of this, the predetermined number may be a number that is large but does not reduce eagerness to buy.

According to the present embodiment, the number of displayed pieces of a product and the number of discarded pieces of the product are used for generation of a forecasting model. This can reduce an opportunity loss resulting from lack of stock and the number of pieces discarded due to overproduction, as in the first embodiment.

### OTHER EMBODIMENTS

The above embodiments have been described as examples of the technique disclosed in the present application. However, the technique disclosed in the present disclosure is not limited to this, and can be applied to embodiments obtained by making changes, replacements, additions, omissions, and the like as appropriate. Therefore, other embodiments will be exemplified below.

In the second embodiment, Q learning is used as an example of reinforcement learning, but a method other than Q learning may be used as reinforcement learning.

In the first and second embodiments, the model generating device 10 outputs the forecasting model information 133 to the demand forecasting device 20, and the demand forecasting device 20 calculates an actual forecast value. However, the model generating device 10 may calculate the actual forecast value. For example, the model generating device 10 may acquire, from the demand forecasting device 20, the demand information 231 indicative of the number of sales of the product at a present time, the discard information 233 indicative of the number of discarded pieces of the product at the present time, the display information 232 indicative of the number of displayed pieces of the product at the present time, and the external information 234, calculate an actual forecast value, and output the calculated forecast value to the demand forecasting device 20.

In the above embodiments, the demand forecasting system 1 is constituted by the model generating device 10 and the demand forecasting device 20. However, all the functions of the demand forecasting system 1 may be realized by a single device (for example, a server).

In the above embodiments, the simulator 121 of the model generating device 10 simulates the number of sales of a product, the number of displayed pieces of the product, and the number of discarded pieces of the product, and the forecasting model generator 122 generates a forecasting model based on the external information 132, and the number of sales of the product, the number of displayed pieces of the product, and the number of discarded pieces of the product and calculates a forecast value by using the forecasting model. As a result, both a reduction in opportunity loss and a reduction in discard cost are achieved. However, the simulator 121 may simulate the number of displayed pieces of the product, and the forecasting model generator 122 may generate a forecasting model based on the external information 132 and the number of displayed pieces of the product and calculate a forecast value by using the forecasting model. In this case, an opportunity loss can be reduced although some discard cost may occur.

Alternatively, the simulator 121 may simulate at least one of the number of sales of the product and the number of discarded pieces of the product in addition to the number of displayed pieces of the product, and the forecasting model generator 122 may generate a forecasting model based on at least one of the number of sales of the product and the number of discarded pieces of the product, the external information 132, and the number of displayed pieces of the product and calculate a forecast value by using the forecasting model.

In the above embodiments, the second acquisition unit in the demand forecasting device 20 acquires the demand information 231, the display information 232, the discard information 233, and the external information 234, and the controller 220 updates the forecasting model based on the demand information 231, the display information 232, the discard information 233, and the external information 234 and calculates a forecast value of demand for the product by using the updated forecasting model. As a result, both a reduction in opportunity loss and a reduction in discard cost are achieved. However, the second acquisition unit may acquire the display information 232 and the external information 234, and the controller 220 may update the forecasting model based on the display information 232 and the external information 234 and calculate a forecast value of the demand for the product by using the updated forecasting model. In this case, an opportunity loss can be reduced although some discard cost may occur.

Alternatively, the second acquisition unit may acquire at least one of the demand information 231 and the discard information 233 in addition to the display information 232 of the product, and the controller 220 may update the forecasting model based on at least one of the demand information 231 and the discard information 233, the display information 232, and the external information 234 and calculate a forecast value by using the updated forecasting model.

### OVERVIEW OF EMBODIMENTS

(1) A model generating device according to the present disclosure includes: an acquisition unit that acquires demand information indicative of the number of sales of a product in a shop for a past predetermined period and external information relevant to the number of sales of the product; and a controller that generates a forecasting model for calculating a forecast value of demand for the product based on the demand information and the external information, wherein the controller includes a simulator that simulates the number of displayed pieces of the product based on the demand information and the forecast value and a forecasting model generator that generates the forecasting model based on the external information and the number of displayed pieces of the product and calculates the forecast value by using the forecasting model.

As a result, it is possible to reduce an opportunity loss resulting from lack of stock.

(2) The model generating device according to (1) may be configured such that the simulator simulates at least one of the number of sales of the product and the number of discarded pieces of the product based on the demand information and the forecast value, and the forecasting model generator generates the forecasting model based on the at least one of the number of sales of the product and the number of discarded pieces of the product, the external information, and the number of displayed pieces of the product and calculates the forecast value by using the forecasting model.

As a result, it is possible to reduce the number of pieces of the product discarded due to overproduction.

(3) The model generating device according to (2) may be configured such that the forecasting model generator calculates an ideal value, which is a desired number of sales of the product, based on the number of sales of the product, the number of displayed pieces of the product, and the number of discarded pieces of the product, updates the forecasting model based on a difference between a previous forecast value and the ideal value by using a Kalman filter, and calculates a next forecast value by using the updated forecasting model.

(4) The model generating device according to (3) may be configured such that the forecasting model is a function for calculating the forecast value by multiplying a weight coefficient and an explanatory variable, and the forecasting model generator generates the explanatory variable based on the number of sales of the product and the external information, calculates the ideal value by changing a value of the number of sales of the product based on the number of displayed pieces of the product and the number of discarded pieces of the product, and updates the weight coefficient based on the difference between the previous forecast value and the ideal value.

(5) The model generating device according to (4) may be configured such that the ideal value is increased in a case where the number of displayed pieces of the product and the number of discarded pieces of the product are zero.

(6) The model generating device according to (2) may be configured such that the forecasting model generator updates the forecasting model by reinforcement learning and calculates the forecast value by using the updated forecasting model.

(7) The model generating device according to (6) may be configured such that the forecasting model is a function for calculating the forecast value based on a state and a reward, and the forecasting model generator sets the state based on the external information, the number of sales of the product, the number of displayed pieces of the product, and the number of discarded pieces of the product and determines the reward based on the number of displayed pieces of the product and the number of discarded pieces of the product.

(8) The model generating device according to (7) may be configured such that the forecasting model generator determines the reward such that the reward increases as the number of discarded pieces of the product decreases and the number of displayed pieces of the product approaches a predetermined number.

(9) The model generating device according to (1) or (2) may be configured such that the external information includes at least one of a time zone, a day of the week, weather, and the number of customers at a parking lot or a store entrance.

(10) A demand forecasting device according to the present disclosure is a demand forecasting device for forecasting demand by using a forecasting model generated by a model generating device according to any one of (1) to (9) and includes a second acquisition unit that acquires display information indicative of the number of displayed pieces of the product at a present time and external information relevant to the number of sales of the product at the present time and a second controller that updates the forecasting model based on the display information and the external information and calculate a forecast value of demand for the product by using the updated forecast model.

(11) The demand forecasting device according to (10) may be configured such that the second acquisition unit acquires at least one of demand information indicative of the number of sales of the product at the present time in the shop and discard information indicative of the number of discarded pieces of the product at the present time, and the second controller updates the forecasting model based on the at least one of the demand information and the discard information, the display information, and the external information and calculates the forecast value of the demand for the product by using the updated forecasting model.

(12) A demand forecasting method according to the present disclosure includes: causing a second acquisition unit (the communication unit 110 and the controller 120) to acquire first demand information indicative of the number of sales of a product in a shop for a past predetermined period and first external information relevant to the number of sales of the product; and causing a computing unit (the controller 120) to generate a forecasting model for calculating a forecast value of demand for the product based on the first demand information and the first external information, wherein the causing the computing unit to generate the forecasting model includes simulating the number of displayed pieces of the product based on the first demand information and the forecast value and generating the forecasting model based on the first external information and the number of displayed pieces of the product and calculating the forecast value by using the forecasting model.

(13) The demand forecasting method according to (12) may be configured such that in the causing the computing unit to generate the forecasting model, at least one of the number of sales of the product and the number of discarded pieces of the product is simulated based on the first demand information and the forecast value, the forecasting model is generated based on the first external information, the number of displayed pieces of the product, and the at least one of the number of sales of the product and the number of discarded pieces of the product, and the forecast value is calculated by using the forecasting model.

(14) The demand forecasting method according to (13) may further include: causing the second acquisition unit (the communication unit 210, the controller 220, the input unit 240, the imaging unit 250) to acquire second demand information indicative of the number of sales of the product at a present time in the shop, display information indicative of the number of displayed pieces of the product at the present time, discard information indicative of the number of discarded pieces of the product at the present time, and second external information relevant to the number of sales of the product at the present time; and causing the computing unit (the controller 220) to update the forecasting model based on the second demand information, the display information, the discard information, and the second external information and calculate a forecast value of demand for the product by using the updated forecasting model.

The model generating device, the demand forecasting device, and the demand forecasting method recited in all claims of the present disclosure are realized by hardware resources, for example, cooperation of a processor, a memory, and a program.

The model generating device according to the present disclosure is useful, for example, as a device that provides a forecasting model. The demand forecasting device according to the present disclosure is useful, for example, as a device that forecasts demand by using a forecasting model.

What is claimed is:

1. A model generating device comprising:
an acquisition unit that acquires demand information indicative of the number of sales of a product in a shop for a past predetermined period and external information relevant to the number of sales of the product; and
a controller that generates a forecasting model for calculating a forecast value of demand for the product based on the demand information and the external information,
wherein the controller includes:
a simulator that simulates the number of displayed pieces of the product based on the demand information and the forecast value; and
a forecasting model generator that generates the forecasting model based on the external information and the number of displayed pieces of the product and calculates the forecast value by using the forecasting model.

2. The model generating device according to claim 1, wherein
the simulator simulates at least one of the number of sales of the product and the number of discarded pieces of the product based on the demand information and the forecast value, and
the forecasting model generator generates the forecasting model based on the at least one of the number of sales of the product and the number of discarded pieces of the product, the external information, and the number of displayed pieces of the product and calculates the forecast value by using the forecasting model.

3. The model generating device according to claim 2, wherein the forecasting model generator calculates an ideal value, which is a desired number of sales of the product, based on the number of sales of the product, the number of displayed pieces of the product, and the number of discarded pieces of the product, updates the forecasting model based on a difference between a previous forecast value and the ideal value by using a Kalman filter, and calculates a next forecast value by using the updated forecasting model.

4. The model generating device according to claim 3, wherein
the forecasting model is a function for calculating the forecast value by multiplying a weight coefficient and an explanatory variable, and
the forecasting model generator generates the explanatory variable based on the number of sales of the product and the external information, calculates the ideal value by changing a value of the number of sales of the product based on the number of displayed pieces of the product and the number of discarded pieces of the product, and updates the weight coefficient based on the difference between the previous forecast value and the ideal value.

5. The model generating device according to claim 4, wherein the ideal value is increased in a case where the number of displayed pieces of the product and the number of discarded pieces of the product are zero.

6. The model generating device according to claim 2, wherein the forecasting model generator updates the forecasting model by reinforcement learning and calculates the forecast value by using the updated forecasting model.

7. The model generating device according to claim 6, wherein
the forecasting model is a function for calculating the forecast value based on a state and a reward, and
the forecasting model generator sets the state based on the external information, the number of sales of the product, the number of displayed pieces of the product, and the number of discarded pieces of the product and determines the reward based on the number of displayed pieces of the product and the number of discarded pieces of the product.

8. The model generating device according to claim 7, wherein the forecasting model generator determines the reward such that the reward increases as the number of discarded pieces of the product decreases and the number of displayed pieces of the product approaches a predetermined number.

9. The model generating device according to claim 1, wherein the external information includes at least one of a time zone, a day of the week, weather, and the number of customers at a parking lot or a store entrance.

10. A demand forecasting device for forecasting demand by using a forecasting model generated by a model generating device comprising an acquisition unit that acquires demand information indicative of the number of sales of a product in a shop for a past predetermined period and external information relevant to the number of sales of the product; and a controller that generates a forecasting model for calculating a forecast value of demand for the product based on the demand information and the external information,
wherein the controller includes:
a simulator that simulates the number of displayed pieces of the product based on the demand information and the forecast value; and
a forecasting model generator that generates the forecasting model based on the external information and the number of displayed pieces of the product and calculates the forecast value by using the forecasting model,
the demand forecasting device comprising:
a second acquisition unit that acquires display information indicative of the number of displayed pieces of the product at a present time and external information relevant to the number of sales of the product at the present time; and
a second controller that updates the forecasting model based on the display information and the external information and calculate a forecast value of demand for the product by using the updated forecast model.

11. The demand forecasting device according to claim 10, wherein
the second acquisition unit acquires at least one of demand information indicative of the number of sales of the product at the present time in the shop and discard information indicative of the number of discarded pieces of the product at the present time, and
the second controller updates the forecasting model based on the at least one of the demand information and the discard information, the display information, and the external information and calculates the forecast value of the demand for the product by using the updated forecasting model.

12. A demand forecasting method comprising:
causing a second acquisition unit to acquire first demand information indicative of the number of sales of a product in a shop for a past predetermined period and first external information relevant to the number of sales of the product; and
causing a computing unit to generate a forecasting model for calculating a forecast value of demand for the product based on the first demand information and the first external information,
wherein the causing the computing unit to generate the forecasting model includes:
simulating the number of displayed pieces of the product based on the first demand information and the forecast value; and
generating the forecasting model based on the first external information and the number of displayed pieces of the product and calculating the forecast value by using the forecasting model.

13. The demand forecasting method according to claim 12, wherein in the causing the computing unit to generate the forecasting model, at least one of the number of sales of the product and the number of discarded pieces of the product is simulated based on the first demand information and the forecast value, the forecasting model is generated based on the first external information, the number of displayed pieces of the product, and the at least one of the number of sales of the product and the number of discarded pieces of the product, and the forecast value is calculated by using the forecasting model.

14. The demand forecasting method according to claim 13, further comprising:
causing the second acquisition unit to acquire second demand information indicative of the number of sales of the product at a present time in the shop, display information indicative of the number of displayed pieces of the product at the present time, discard information indicative of the number of discarded pieces of the product at the present time, and second external information relevant to the number of sales of the product at the present time; and
causing the computing unit to update the forecasting model based on the second demand information, the display information, the discard information, and the second external information and calculate a forecast value of demand for the product by using the updated forecasting model.

15. A non-transitory computer readable medium including a program causing a computer to execute:
acquiring first demand information indicative of the number of sales of a product in a shop for a past predetermined period and first external information relevant to the number of sales of the product; and
generating a forecasting model for calculating a forecast value of demand for the product based on the first demand information and the first external information, wherein generating the forecasting model includes:
simulating the number of displayed pieces of the product based on the first demand information and the forecast value; and
generating the forecasting model based on the first external information and the number of displayed pieces of the product and calculating the forecast value by using the forecasting model.
